(19) United States
(12) Patent Application Publication
(10) Pub. No.: US 2010/0021308 A1
(43) Pub. Date: Jan. 28, 2010

(54) Aerofoil and method of making an aerofoil

(75) Inventor: John A. Rawlinson, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/457,786

(22) Filed: Jun. 22, 2009

(30) Foreign Application Priority Data
Jul. 22, 2008 (GB) 0813381.1

(51) Int. Cl. F01D 5/18; B23P 15/02

(52) U.S. Cl. 416/232; 29/889.72

(57) ABSTRACT

An aerofoil 50 and in particular an aerofoil utilised as a turbine blade within gas turbine engines generally incorporate passages 52, 53 along which fluid flows to provide cooling within the aerofoil 50. Previously straight webs were utilised in order to define passages but such configurations limit design choices with regard to achieving torsional and flap vibrational characteristics. By provision of webs 51 which have chordal variation in a serpentine or S shape wider design choices are provided with respect to achieving torsional and flat vibration control. Webs 51 with such chordal variation are achieved through manufacturing processes which remove forming cores by leaching or a lost wax technique or other erosion process. It will also be understood that chordal variations in the webs can create flow rate variations to facilitate particulate separation in a fluid flow through the passages 52, 53 within an aerofoil.

The present invention relates to aerofoils and more particularly to aerofoils utilised in gas turbine engines and in particular with regard to turbine blades.

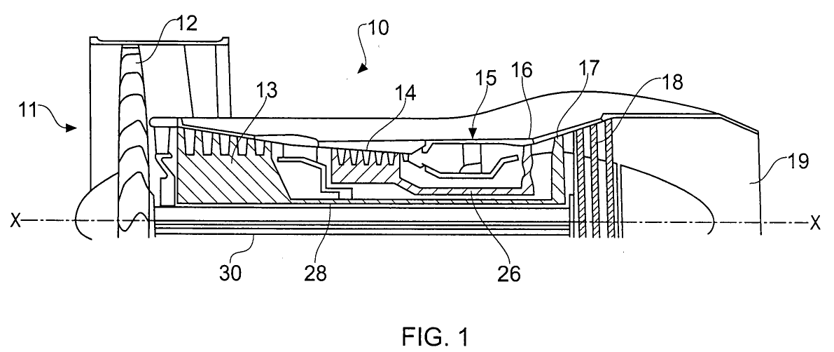

Referring to FIG. 1, a gas turbine engine is generally indicated at 10 and comprises, in axial flow series, an air intake 11, a propulsive fan 12, an intermediate pressure compressor 13, a high pressure compressor 14, a combustor 15, a turbine arrangement comprising a high pressure turbine 16, an intermediate pressure turbine 17 and a low pressure turbine 18, and an exhaust nozzle 19.

The gas turbine engine 10 operates in a conventional manner so that air entering the intake 11 is accelerated by the fan 12 which produce two air flows: a first air flow into the intermediate pressure compressor 13 and a second air flow which provides propulsive thrust. The intermediate pressure compressor compresses the air flow directed into it before delivering that air to the high pressure compressor 14 where further compression takes place.

The compressed air exhausted from the high pressure compressor 14 is directed into the combustor 15 where it is mixed with fuel and the mixture combusted. The resultant hot combustion products then expand through, and thereby drive, the high, intermediate and low pressure turbines 16, 17 and 18 before being exhausted through the nozzle 19 to provide additional propulsive thrust. The high, intermediate and low pressure turbines 16, 17 and 18 respectively drive the high and intermediate pressure compressors 14 and 13 and the fan 12 by suitable interconnecting shafts 26, 28, 30.

In view of the above it will be appreciated that aerofoils and in particular aerofoils utilised for turbine blade design must have a degree of cooling to remain operationally practicable. Such cooling involves provision of cooling passages and cavities within the blade. Traditionally such cooling passages have been formed through a hollow internal core defined by radial webs. Internal cooling passages are provided at least from one end of the aerofoil along which coolant can flow to provide internal cooling through multipass processes as well as surface film cooling through surface apertures in the aerofoil.

With coolant radial webs it will be appreciated that the webs provide internal structural support and therefore effect both torsional and flap vibration characteristics for the aerofoil in use. Such characteristics will in such circumstances influence the design of the aerofoil to achieve desired vibrational and other characteristics.

Straight radial webs are used to a substantial extent in aerofoils made by traditional casting and design processes. It will be understood that a uniform radial direction provides minimal stress and enables ready removal of a forming or casting core. Such provision of straight radial webs and straight cooling passages restricts an aerofoil designer with regard to their capability to tune the webs within the hollow core for vibrational control and other design parameters.

In accordance with aspects of the present invention there is provided an aerofoil having a hollow core with a web to define a passage, the web extending within the core between flanks of the aerofoil and the web formed with a chordal variation along the web between a leading edge and a trailing edge of the aerofoil whereby the web adopts an S or serpentine shape along the length of said aerofoil.

Possibly, the chordal or spanwise variation is arranged to vary cross sectional area of the hollow core within the aerofoil.

Possibly, the hollow core is arranged to receive a fluid flow and the chordal variation guides such fluid flow to facilitate particle separation by relative flow variation across the fluid flow about the chordal or spanwise variation. Possibly the chordal variation is configured to facilitate a desired heat transfer characteristic for the aerofoil.

Possibly, the web has a variable thickness. Possibly, the web has a variable width. Possibly, the web has a smooth surface. Alternatively, the web has a textured surface. Possibly, the web has a variable textured surface along its length.

Also in accordance with aspects of the present invention there is provided a method of forming an aerofoil comprising defining a forming core having a chordal variation, forming an aerofoil about the forming core, removing the forming core to leave an aerofoil having webs which define passages with webs having the chordal variation between flanks of the aerofoil within the now hollow core left by removal of the forming core, whereby the webs each adopt a S or serpentine shape along the length of said aerofoil.

Typically, the method for removing the forming core is by leaching or a lost wax type technique.

Embodiments of aspects of the present invention will now be described by way of example only with reference to the accompanying drawings in which:

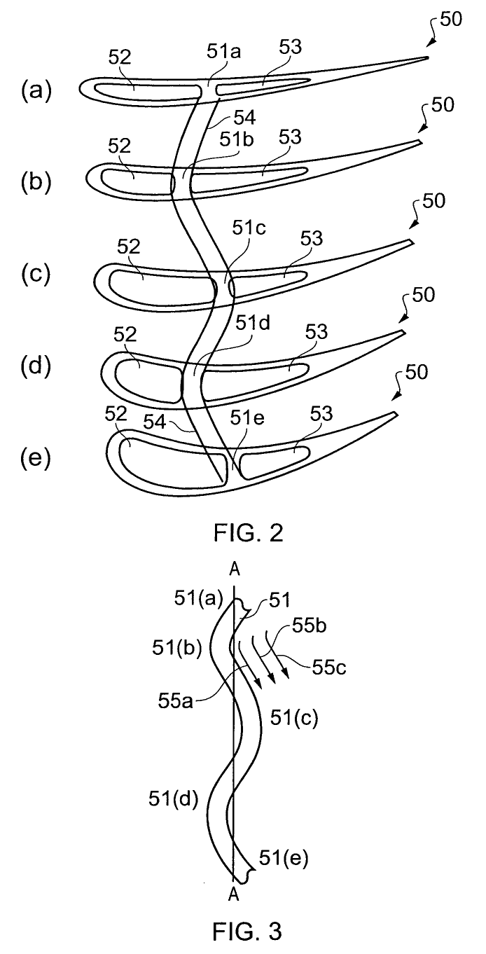

FIG. 2 provides a schematic plan cross section of an aerofoil at a number of positions along its length; and

FIG. 3 is a schematic illustration of a chordal variation within a web in accordance with first aspects of the present invention;

As indicated above internal webs within an aerofoil such as a turbine blade enables definition for cooling passages. Such internal webs also provide reinforcement and therefore adjust the torsional and vibration characteristics of the aerofoil. An ability to allow greater tuning by an aerofoil designer to particular localised requirements would be advantageous. In such circumstances in accordance with aspects of the present invention aerofoils are formed typically using a leaching or lost wax process in order to define an internal hollow core using appropriate moulding or casting techniques. By such a leaching or lost wax technique a moulding or forming core can be removed without consideration with regard to providing straight withdrawal passages for a typical and conventional straight casting core once forming of the aerofoil has been completed. In such circumstances as described below internal webs which have spanwise features and in particular a chordal variation can be provided. By chordal what is meant is that the variation generally extends along a line between a leading edge and a trailing edge of the aerofoil hollow core. The variation in the web extending between opposed flanks which can be referred to as the pressure side and the suction side.

Provision of variation allows an aerofoil designer to tune a particular aerofoil design for vibration, heat transfer and other characteristics. It will be understood by creating a spanwise variation along with variations in thickness or width of the web an aerofoil designer can adjust the responsiveness of the aerofoil to presented torsional and flat vibrational characteristics as well as provide a desired heat transfer response.

FIGS. 2 and 3 provide a schematic view of an embodiment of an aerofoil 50 in accordance with the present invention. The aerofoil 50 incorporates a web 51 in order to define a hollow core with passages 52, 53. As indicated previously these passages 52, 53 generally act as cooling passages for a coolant fluid flow within the aerofoil 50. FIG. 2 provides a schematic plan cross section of the aerofoil 50 at different positions along its length whilst FIG. 3 provides a schematic side illustration of the web 51 as it extends generally longitudinally or spanwise in the blade 50 from a rotor mounting in use.

It will be noted that the web 51 in accordance with the present invention is configured and shaped such that there is a chordal variation in the web 51 along the principal axis A-A of the aerofoil 50. In such circumstances as more clearly illustrated in FIG. 3 the web 51 adopts an S or serpentine shape along the length of the aerofoil 50 between the passages 52, 53. Such an S configuration allows adjustment and design variation for the aerofoil 50 to meet torsional and flap vibrational characteristic requirements whilst maintaining a withdrawal angle for removal of forming cores and general shaping of the aerofoil 50. The web 51 may also tune the aerofoil to give a desired heat transfer response.

By creating a chordal variation it will be understood that the internal web 51 allows alteration in the aerofoil 50 characteristics to meet torsional, heat transfer and vibrational characteristics at different points upon the aerofoil in use. It will be understood that the minimum moment of area affecting the torsional mode may be varied whilst the area influencing the flap vibrational modes may be kept constant or at least varied independently dependent upon requirements. Such capability for design choice is in stark contrast with prior straight webs utilised to define cooling passages within an aerofoil.

FIG. 2a illustrates at a first position for the web 51 a at one end of the chordal variation provided for examplary illustration purposes whilst FIG. 2e illustrates the web 51e at another end of the variation provided for illustration purposes. It will be noted that FIG. 2b, FIG. 2c and FIG. 2d respectively illustrate positions for the web 51b, 51c, 51d as the web 51 subtends its chordal variation through an S or serpentine shape along the axial length or direction A-A of the aerofoil. FIG. 2 also provides for illustration purposes broken line 54 which correspond with FIG. 3 to illustrate the chordal variation in the web 51. It will be noted that the extent of variation either side of the aerofoil axis A-A between the flanks of the aerofoil can be determined and adjusted dependent upon requirements for design, manufacturing capability and materials type. As indicated above generally a leaching or lost wax type technique will be utilised for removal of forming cores in a manufacturing process for the aerofoil 50.

In addition to providing capability with regard to adjusting aerofoil 50 design for torsional and vibrational considerations it will also be understood that generally the passages 52, 53 will carry coolant flows. These coolant flows may be air or liquid but in any event may incorporate particles as debris or otherwise. Such particles and debris may cause abrasion and other problems including blockage of coolant apertures such as those utilised for film cooling within the aerofoil 50 as well as other restrictions. In such circumstances, removal of particles from the coolant flow may be advantageous. By provision of a chordal variation in the web 51 in accordance with aspects of the present invention a degree of particle separation may be achieved. For illustration purposes FIG. 3 incorporates arrows 55 to illustrate a fluid flow about the web 51. It will be appreciated that the influence of the web 51 in terms of guiding and altering the flow 55 will depend upon how close the flow 55 is to the web 51. In such circumstances different relative rates of flow may be achieved between coolant flows 55a adjacent the web 51 and progressively through flows 55b, 55c lower or higher flow rates achieved. It will be understood that the capability of the flow 55 to retain particles in suspension and in stream depends to an extent upon the flow rate. In such circumstances, changes in the flow rate 55 can be utilised in order that particles fall from suspension and entrainment and therefore can be collected by an appropriate mechanism. Such mechanism may include provision of a scoop or other diverter or more significant removal by a filter for particulate matter. In such circumstances towards one end of the aerofoil 50 the marginal concentration of particles due to a flow rate separation process as described above may be utilised as an initial process for particle separation to enhance the effectiveness of other particle removal and separation techniques for the flow.

It will be understood as indicated above generally the web can be of variable thickness and width. Such variations may be utilised to facilitate changes in both vibrational and torsional response dependent upon design requirements as well as to enhance particle separation and achieve desired heat transfer characteristics.

It will be understood that aerofoils 50, in accordance with the present invention depend upon the capability with regard to removal of a forming core which does not require physical displacement of the forming core. It will be appreciated that the chordal variations would inhibit such physical removal. In such circumstances erosion techniques as indicated such as leaching with an appropriate leaching solution or a lost wax technique may be utilised to remove a forming core. In such circumstances it will be understood that suitable forming cores will be created to define the passages 52, 53 as part of respective hollow cores. The aerofoil 50 can be formed by appropriate moulding or casting or other forming techniques about the cores. Once the aerofoils 50 is moulded or cast it will be appreciated as described above leaching, or a lost wax technique or other erosion technique for removal of the forming cores are utilised.

It will be understood that generally the webs 51 will have a relatively smooth surface defined by the forming cores utilised to create the aerofoil 50. As an alternative it will be appreciated that all or parts of the surfaces may be roughened or otherwise textured to create greater variations in relative flow and therefore potential enhancement with respect to particle separation as a result of such flow variations. It will be understood examples of such surface features may comprise cross hatching or stippling to the forming cores which will then be replicated in the webs when defined in accordance with methods of aspects of the present invention. As indicated such surface features for the webs 51 will extend along all surfaces of the webs 51 or only on one side of the webs 51 or at particular parts of the webs 51 such as at apex or trough positions dependent upon requirements.

Although illustrated with a single web 51 in an aerofoil 50 in accordance with the present invention it will be appreciated that more than one web in accordance of the present invention may be incorporated within an aerofoil dependent upon requirements.

It will be appreciated aerofoils in accordance with the present invention are generally utilised in gas turbine engines which may provide propulsion for aircraft. In such circumstances weight may be important. The present invention allow utilisation and provision of a web which has a chordal variation to adjust torsional and flat vibrational characteristics. In such circumstances it may be possible to utilise a thinner web and therefore less material to reduce the weight of each web whilst achieving the same torsional and flap vibrational characteristics in comparison with prior straight webs. This could be advantageous with regard to as indicated utilisation of aerofoils in weight sensitive situations.

As indicated above the webs provided in accordance with the present invention effectively define passages which generally act as coolant passages within the aerofoil. Flow control in terms of constriction and guiding in such circumstances may be provided through the webs. In order to provide such guiding and constriction variation for fluid flow control it will be understood the webs through their chordal variations may adjust the available lateral cross sectional area of the respective hollow core in the passages variably along the lengths of the aerofoil for such flow control.

It will be appreciated that the webs in accordance of the present invention may not be continuous along the length of the aerofoil and therefore have gaps between respective passages.

1. An aerofoil having a hollow core with a web to define a passage, the web extending within the core between flanks of the aerofoil and the web formed with a chordal variation along the web between a leading edge and a trailing edge of the aerofoil, whereby the web adopts a S or serpentine shape along the length of said aerofoil.

2. An aerofoil as claimed in claim 1 wherein the chordal variation is arranged to vary the cross-sectional area of the hollow core along the aerofoil.

3. An aerofoil as claimed in claim 1 wherein the hollow core is arranged to receive a fluid flow and the chordal variation guides such fluid flow to facilitate particle separation by relative flow variation across the fluid flow about the chordal variation.

4. An aerofoil as claimed in claim 1 wherein the chordal variation is configured to facilitate a desired heat transfer characteristic.

5. An aerofoil as claimed in claim 1 wherein the web has a variable thickness.

6. An aerofoil as claimed in claim 1 wherein the web has a variable width.

7. An aerofoil as claimed in claim 1 wherein the web has a smooth surface.

8. An aerofoil as claimed in claim 1 wherein the web has a textured surface.

9. An aerofoil as claimed in claim 8 wherein the web has a variable textured surface along its length.

10. An aerofoil as claimed in claim 1 configured to provide a turbine blade within a gas turbine engine.

11. A method of forming an aerofoil comprising defining a forming core having a chordal variation, forming an aerofoil about the forming core, removing the forming core to leave an aerofoil having webs which define passages with webs having the chordal variation between flanks of the aerofoil within the now hollow core left by removal of the forming core, whereby the webs each adopt a S or serpentine shape along the length of said aerofoil.

12. A method as claimed in claim 11 wherein the method for removing the forming core is by leaching or a lost wax type technique.

13. A gas turbine engine incorporating an aerofoil as claimed in claim 1.

14. A gas turbine engine incorporating an aerofoil formed by a method as claimed in claim 11.
